(19) United States
(12) Patent Application Publication
(10) Pub. No.: US 2006/0228076 A1
(43) Pub. Date: Oct. 12, 2006

(54) Parallel optical interface

(75) Inventor: Michael B. Neary, Manhattan Beach, CA (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/093,038

(22) Filed: Mar. 30, 2005

(51) Int. Cl. G02B 6/36

(52) U.S. Cl. 385/89

(57) ABSTRACT

A communication coupling technique is disclosed that uses optical signals separators that may be formed using optical wave guides, hollow tubes, or any material that separates signals emitted from one source from signals emitted from other sources.

### BACKGROUND

Communication between electronic components including chips, circuit boards, units, etc., has traditionally used copper wiring such as traces on a printed circuit board (PCB) or back panel, or cables. Increasing circuit complexity has necessitated increasing the number of connections between PCBs, for example, so that the distance between adjacent wires has become very small introducing alignment difficulties between PCBs, back panel connectors and other connection techniques that transmit signals from one component to another.

### SUMMARY

A communication coupling technique using optical signals separators is disclosed in which low cost light source and sensor components and signal separating elements are used to achieve optical communication. Light sources and/or sensors are configured on each communicating unit such as xerographic color copiers, printers or other types of equipment such as computers, servers, etc. so that a light source and a light sensor at opposite ends of an optical signals separator may communicate with each other.

The optical signals separator may be formed using optical wave guides such as optical fibers. However, hollow tubes, or any material that separates signals emitted from one source from signals emitted from other sources forming light pies also may be used. The optical signals separator may take on the form of a rectangular block or a flexible flat like cable that includes light pipes extending between opposing surfaces of the rectangular block or ends of the flexible flat cable. End faces of the light pipes may be arranged on the surfaces in a specific configuration. Such configuration may match a configuration of sources or sensors of one of the communicating units. For example, if sources and/or sensors are configured on a top portion of a circuit board or back end of a hard disk unit, light pipe end faces of the optical signals separator may also be similarly configured in a one-to-one fashion so that light from sources may be transmitted through the light pipes to a corresponding sensors on another circuit board or a back panel.

Instead of having a one-to-one relationship between light pipes and sources, cross-sections of the light pipes may be made smaller than a light emitting surface of a source so that more than one light pipe may assist in transmitting light emitted from a source to a sensor. The end faces of the light pipes may then be packed to fit tightly within a perimeter of a surface of the optical signals separator. In this way, alignment requirements between the optical signals separator and the sources and/or sensors of a unit may be substantially removed so that only those light pipes whose end faces are immediately adjacent to light emitting surface of a source transmit light to a corresponding sensor.

The optical signals separator may be substantially devoid of other types of components except for any alignment devices that may assist aligning the light pipes to sources and sensors. In this way, optical signals separators may be used like a connector or cable to interconnect adjacent circuit boards, subunits or units.

### BRIEF DESCRIPTION OF THE DRAWINGS

Various disclosed exemplary embodiments of the systems and methods will be described in detail, with reference to the following figures, wherein:

FIG. 1 shows an example of two circuit boards mounted on a back panel and interconnected by an optical signals separator;

FIG. 2 shows sources and sensors disposed on top portions of each of the circuit boards shown in FIG. 1;

FIG. 3 shows an exemplary configuration of the sources and sensors of FIG. 2;

FIG. 4 shows an exemplary schematic diagram of light divergence;

FIG. 5 shows interference caused by light divergence;

FIG. 6 shows an exemplary optical signals separator that reduces interference;

FIG. 7 illustrates exemplary parameters related to alignment of the optical signals separator;

FIG. 8 shows a second exemplary optical signals separator;

FIG. 9 shows an additional optical signals separator alignment parameter;

FIG. 10 shows a first exemplary rectangular block optical signals separator;

FIG. 11 shows a second exemplary rectangular block optical signals separator;

FIG. 12 shows an exemplary ribbon like optical signals separator;

FIG. 13 shows an exemplary application of the ribbon like optical signals separator of FIG. 12; and

FIG. 14 shows an exemplary circuit diagram that may be associated with the sources and sensors.

### DETAILED DESCRIPTION OF EMBODIMENTS

FIG. 1 shows an exemplary electronic device 100 that may include a back panel 102 having connectors 106 and 110. The electronic device 100 may be included in any type of equipment including devices, such as xerographic copiers or printers, scanners, computers, etc. Circuit boards 104 and 108 may be inserted into connectors 106 and 110 for communication with other components reachable through back panel 102. An optical signals separator 112 may be provided that couples top portions of circuit boards 104 and 108 to provide a parallel optical interface between circuit boards 104 and 108.

Optical signals separator 112 is distinguished from what appeared to be complex and costly back panel “optical wiring” techniques such as hoped to be possible by some IBM and Agilent projects. (See http://www.darpa.mil/mto/c2oi/IBM.htm, Mar. 16, 2005.) There, Terabit/second rates are contemplated to be formed on back panels that include wires and other components such as connections, etc. Here, optical signals separators are directed to low cost coupling using inexpensive and readily available components such as common light emitting diodes (LEDs) or even incandescent lights. Further, instead of sophisticated “optical wiring,” simple hollow tubes or inexpensive optical fibers may be used, for example. In addition, the optical signals separator is substantially standalone not formed with other components with minor exceptions where convenience requires.

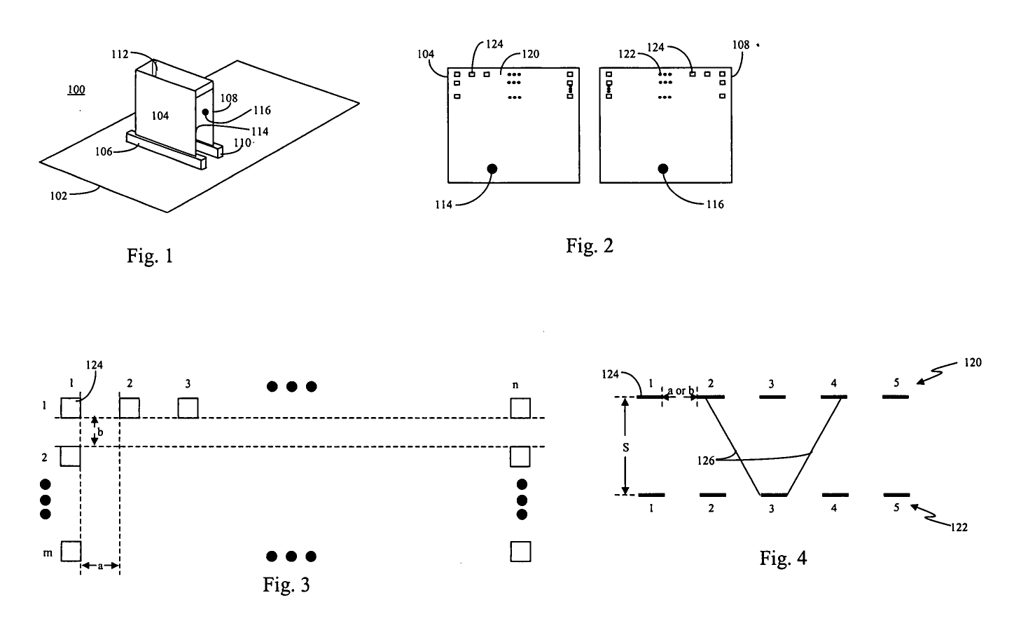

FIG. 2 shows an exemplary diagram of inner surfaces 114 and 116 of circuit boards 104 and 108, respectively, that face each other. Top portions of inner surfaces 114, 116 may include a plurality of sources/sensors 124 arranged together to form source/sensor blocks 120 and 122. The sources/sensors 124 may be discrete components disposed on surfaces 116 or may be a single component containing all the sources/sensors 124 needed for communication. Sources may be light emitting diodes, laser diodes, incandescent lights or other light sources that meet desired communication requirements. Sensors may be any type of light detectors. Sources/sensors 124 of boards 104 and 108 may be connected to other circuit elements so that communication may be achieved between circuit boards 104 and 108 via the sources/sensors 124. While source/sensor blocks 120 and 122 are shown to have mirror image configurations, other configurations may be used. To achieve communication, a light source of the circuit board 104 outputs light that is sensed by a corresponding light sensor of circuit board 108 and/or vice versa.

FIG. 3 shows a possible exemplary array configuration of one source/sensor block 120 or 122. As an example, each source/sensor 124 is shown to have a square perimeter. However, other perimeter shapes are possible such as circles, ellipses or irregular perimeter shapes. Additionally, while FIG. 3 shows the sensors/detectors 124 arranged as a two-dimensional array, other arrangements may also be used as may be convenient. For example, sensors 124 may be placed in a staggered pattern.

In the particular example shown in FIG. 3, sources/sensors 124 are arranged in an n-by-m two dimensional array where adjacent row sources/sensors 124 are separated by a distance “a” and adjacent column sources/sensors 124 are separated by a distance “b”. Thus, using conventional (row, column) as subscripts, the right edge of source/sensor 124 (1,1) is separated from the left edge of source/sensor 124 (1, 2) by a distance a; and the bottom edge of source/sensor 124 (1,1) is separated from the top edge of source/sensor (2, 1) by a distance b. Distances a and b may be selected based on parameters such as source/sensor packing density, cross-talk, etc.

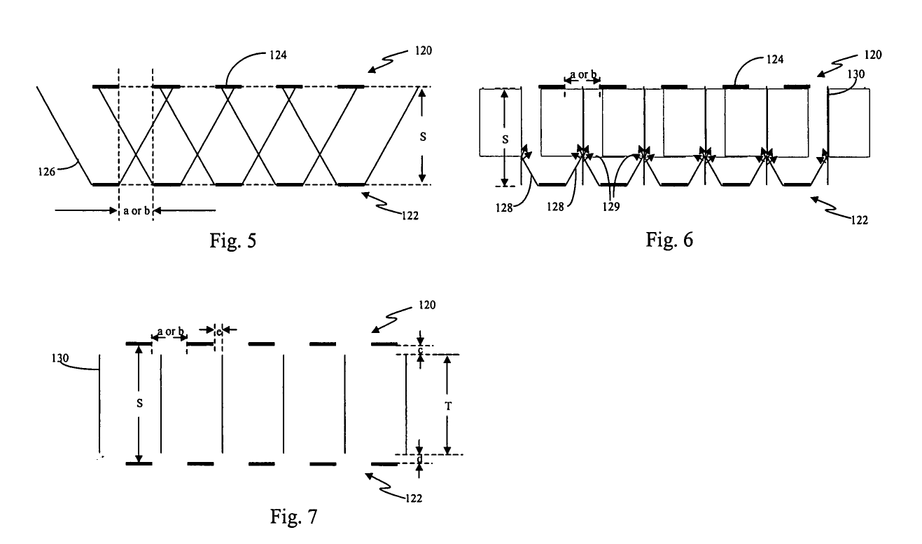

FIG. 4 shows an exemplary configuration of source/sensor blocks 120 and 122 positioned to face each other when circuit boards 104 and 108 are adjacently arranged as shown in FIG. 1. For this example, assume that sources/sensors 1-5 of the source/sensor block 122 are all sources and sources/sensors 1-5 of source/sensor block 120 are all sensors, and light emitting or receiving surfaces (active surfaces) of opposing sources/sensors 124 are separated from each other by a distance S. Thus, signals from sources 1-5 of source/sensor block 122 are intended to be received by sensors 1-5 of sensors 1-5 of source/sensor block 120. Light from source 3 of source/sensor block 122 may radiate toward source/sensor block 120 in a cone like manner as represented by lines 126. As shown, light from source 3 of source/sensor block 122 is received by sensors 2-4 of source/sensor block 120. Source 3's light signal that is received in error by sensors 2 and 4 is an interference signal or noise relative to light signals from sources 2 and 4, respectively. Thus, signal-to-noise ratios of communications between sources 2, 4 and sensors 2, 4 of source/sensor blocks 122 and 120 are reduced. When cones of all sources 1-5 of the source/sensor block 122 are shown as in FIG. 5, the signal-to-noise ratios of all sensors are degraded by interfering signals from other ones of the sources 124.

The signal-to-noise ratios of the configuration shown in FIG. 5 may be improved by adding an optical signals separator 130 that reduces light interference from sources other than the desired one. As shown in FIG. 6, optical signals separator 130 provides light pipes that separate the sources and sensors 124 of the source/sensor blocks 120 and 122 so that light from sources 124 is substantially prevented from reaching sensors 124 that correspond to other sources 124. The light pipes may be either solid such as optical fibers, hollow tubes or other types of dividers that reduce light transmission from undesired sources such as parallel material opaque to the light of interest. When the light pipes are hollow, light emitted from sources 124 may be reflected from inner surfaces as illustrated by arrows 129. These reflections assist light propagation even around transmission path bends when transmitted signals are base band on/off signals at sufficient low frequencies. However, if sophisticated encoding or modulation techniques are used, such reflection encourage modes of transmission that may decrease signal-to-noise ratio and thus are undesirable. In such situations, optical wave guides such as optical fibers may be the best optical signals separator medium. Thus, optical signals separator 130 may be light pipes such as optical fibers including fibers that are cross-sectionally doped to achieve desirable index of refraction cross-sections, tubes made from material(s) that tend to separate light signals generated by the sources 124, or lens systems that focus light from sources onto corresponding sensors 124, etc.

In practical implementations, optical signals separator 130 may be mounted between top portions of inner surfaces 114 and 116 of circuit boards 104 and 108. When so mounted, facing surfaces of the optical signals separator 130 may not be perfectly aligned relative to source/sensor blocks 120 and 122. Facing surfaces of the optical signals separator are surfaces at which light pipes terminate and “face” the source/sensor blocks 120 and 122. Facing surfaces of optical signals separator 130 may be displaced from the sources and sensors 124 adjacent surfaces by distances “c” and “d” and light pipe boundaries may be displaced from perimeter of sources/sensors 124 by a distance “e” as shown in FIG. 7. One alignment criterion may be that optical signals separator 130 is aligned when the distance e is equal to a/2 between adjacent sources/sensors 124 along a row (for two dimensional array configurations) or b/2 along a column. However, due to manufacturing and assembly tolerances, a distance Δe may be introduced. Δe must be tolerated but controlled. The value of Δe should account for all sources of possible misalignment such as variations in source/sensor block positions when formed on the circuit boards 104 and 108, circuit board-back panel mounting position variations, and the like. The tolerance range of Δe could be determined based on the distances a, b, c, d, the light divergence of the light sources and/or desired signal-to-noise ratio. In a preferred embodiment where c, d<<a and b, Δe may have a value of not greater than about ±a/4 along the row dimension and ±b/4 along the column dimension for two dimensional array source/sensor configurations.

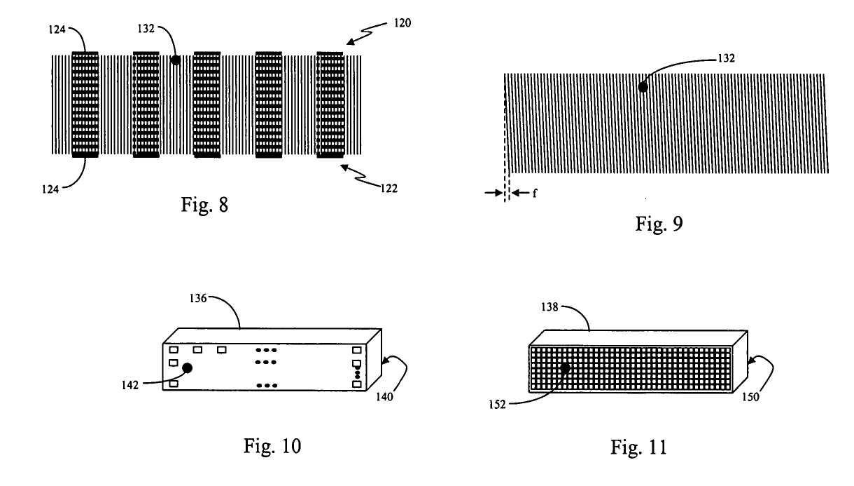

FIG. 8 shows another optical signals separator 132 that may alleviate some of the alignment requirements. Instead of having a single light pipe for transmitting light for one source 124, light pipes with end face cross-sections that are smaller than the active surface of light source 124 are packed together so that a plurality of light pipes provide coupling between one source 124 and one sensor 124. As shown in FIG. 8, optical signals separator 132 may include many light pipes so that light from a single source 124 is transmitted through many light pipes to the corresponding sensor 124. The number of light pipes per source 124 may range from more than one to as many as possible limited only by technology and cost. A range of 5-10 light pipes per source 124 is envisioned.

Optical signals separator 132 substantially removes the need to align the light pipes to the sources 124 and sensors 124 because light emitted from a source 124 substantially propagates through light pipes having end faces that are adjacent to the active surface of the source 124. Light pipes that are not adjacent to the active surface of the source 124 receives a substantially reduced amount of light (if any) from light source 124. Thus, the light pipes having end faces that are adjacent to the active surface of the source 124 collectively form a single light pipe that transmits the emitted light. Thus, optical signals separator 132 substantially reduces the need to align facing surfaces of optical signals separator 132 with sources or sensors 124 of the source/sensor blocks 120 and 122.

While optical signals separator 132 does not require alignment to sources or sensors 124, the light pipes may not necessarily extend perpendicularly to the end surfaces. For example, as shown in FIG. 9, if the light pipes of the optical signals separator 132 form an angle relative to the bottom end surface, then a misalignment of a distance “f” will result. The distance f may be accounted for in the overall alignment tolerance calculation when mounting optical signals separator 112 and 132.

FIG. 10 shows an example of a rectangular block optical signals separator 136. Other multisurface blocks may also be used such as triangular, pentagonal, hexagonal, etc. The light pipes are arranged in a substantially parallel fashion extending between a pair of opposing surfaces 140 and 142. The end faces of the light pipes on surfaces 140 and 142 may match the configuration of the sources and sensors 124 of source/sensor blocks 120 and 122 so that when optical signals separator 136 is placed between adjacent circuit boards 104 and 108, the end faces of the light pipes of are aligned with the sources and sensors of source/sensor blocks 120 and 122. While this example assumes the light pipes to extend between only two of the available surfaces, extension between any number of surfaces are also possible.

FIG. 11 shows another rectangular block optical signals separator 138 that includes light pipes having cross-sections smaller than active surfaces of sources 124 similar to that discussed in connection with FIG. 8. While the light pipe cross-sections are shown as squares and arrange in rows and columns, any cross-section shapes or arrangement combination may be used. In this configuration, the facing surfaces 150 and 152 of optical signals separator 138 may be substantially filled with end faces of the light pipes of the optical signals separator 138. The optical signals separator 138 may be mounted adjacent to the inner surfaces 114, 116 of circuit boards 104 and 108, for example, without having to align a specific light pipe to a corresponding source or sensor 124. As discussed above, light from a source 124 travels through light pipes having end faces adjacent to a source 124; and a sensor 124 is adjacent to opposite ends of at least one of the light pipes. Thus, as long as corresponding sources and sensors 124 of the source/sensor blocks 120 and 122 are sufficiently aligned and the distance f is small relative to the active surfaces of the sources and sensors 124, communication between the circuit boards 104 and 108 may be achieved.

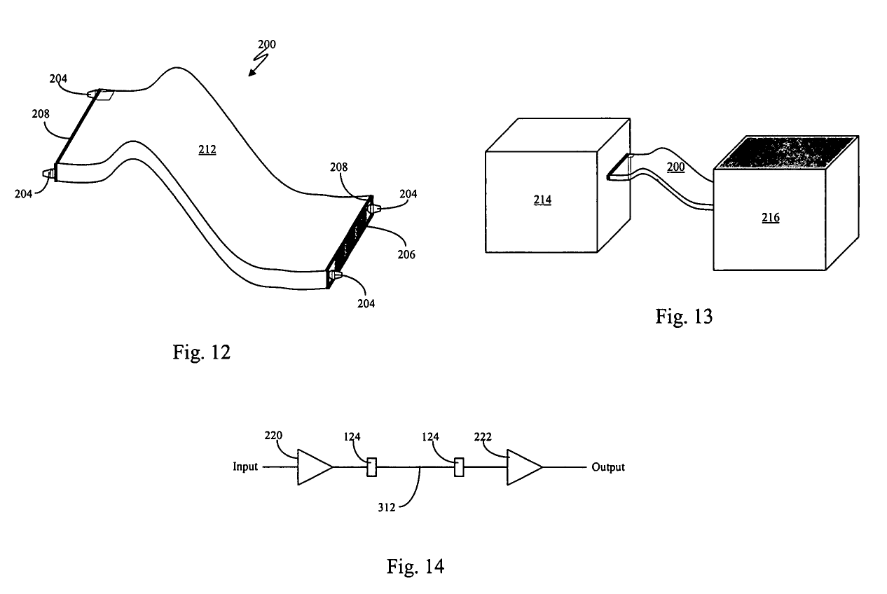

FIG. 12 shows another optical signals separator 200 that includes flexible light pipes 212 that optically connect the facing surfaces 206 and 208 to each other. Similar to configurations shown in FIG. 10 and FIG. 11, the light pipes 212 may be either arranged in a specific configuration where the end faces of each of the light pipes corresponds to one source or sensor 124, or end faces of light pipes having small cross-sections relative to source/sensor active surfaces so that surfaces 206 and 208 are packed with a number of light pipe end faces so that more than one light pipe serve a source 124.

The surfaces 206 and 208 of the optical signals separator 200 may include aligning pins 204 that are disposed in a specified relationship to the light pipe end faces. The aligning pins 204 may be inserted into corresponding alignment holes of units such as units 214 and 216 as shown in FIG. 13, circuit boards 102, 104 and/or back panel 102. The units 214 and 216 may be disk drives, optical drives, etc., or xerographic equipment such as copiers, printers, scanners, personal computers, or any other type of units. For example, the optical signals separator 200 may be used to perform functions corresponding to that performed by flat ribbon cable within units such as personal computers.

As shown in FIG. 14, a source 124 may be connected to a sensor 124 via a light pipe of optical signals separator 312. Source 124 may be driven by signals from an input via a driver 220. Sensor 124 may output a signal to a receiver 222 that buffers or amplifies the received signal and outputs the signal to other circuit elements. The input to the driver 220 may be simple binary base band signals or modulated signals having complex encoding, for example. When such complex signals are used, source and sensors 124 and may be selected to match such complexity and corresponding decoding circuits may be provided at the receiving end.

It would be appreciated that various of the above-disclosed and other features and functions or alternatives thereof, may be desirably combined into many other different systems or applications. Also, that various presently unseen or unanticipated alternatives, modifications, variations or improvements therein may be subsequently made by those skilled in the art which are also intended to be encompassed by the following claims.

What is claimed is:

1. A parallel optical interface, comprising:
a first plurality of light sources and/or light sensors having a first fixed physical configuration;
a second plurality of light sources and/or light sensors having a second fixed physical configuration corresponding to the first fixed physical configuration; and
an optical signals separator that couples one of the first plurality of light sources and light sensors to one of the second light sources and light sensors, the optical signals separator substantially not formed together with other components.

2. The parallel optical interface, further comprising:
at least two facing surfaces of the optical signals separator; and
a plurality of light pipes extending between two of the at least two facing surfaces, end faces of the light pipes having a fixed configuration on the facing surfaces.

3. The parallel optical interface of claim 2, further comprising:
a first alignment device disposed at an end of the optical signals separator that includes one of the facing surfaces, the alignment device aligning the one of the facing surfaces to one of the first or second plurality of light sources and/or light sensors.

4. The parallel optical interface of claim 3, further comprising:
a second alignment device disposed in a fixed relationship relative to one of the first or second plurality of light sources and light sensors, the second alignment device coordinating with the first alignment device to align one of the facing surfaces to one of the first or second plurality of light sources and/or light sensors.

5. The parallel optical interface of claim 4, the first alignment device being a pin and the second alignment device being a hole into which the first alignment device is inserted to align the one of the facing surfaces, or the second alignment device being a pin and the first alignment device being a hole into which the second alignment device is inserted to align the one of the facing surfaces.

6. The parallel optical interface of claim 5, further comprising boundaries between adjacent light pipes, each of the boundaries aligned between perimeters of adjacent light sources and/or light sensors, to be not greater than one quarter of a distance between the perimeters of the adjacent light sources and/or light sensors.

7. The parallel optical interface of claim 2, further comprising a first fixed configuration and a second fixed configuration of the fixed configuration, the first fixed configuration coupling to the first fixed physical configuration and the second fixed configuration coupling to the second fixed physical configuration.

8. The parallel optical interface of claim 7, further comprising a first number of light pipes and a second number of the first plurality of light sources and/or light sensors, the first number being equal to the second number.

9. The parallel optical interface of claim 8, each of the light pipes coupling one of the first light sources and/or light sensors to one of the second light sources and/or light sensors.

10. The parallel optical interface of claim 7, further comprising a first number of light pipes and a second number of the first plurality of light sources and/or light sensors, the first number being greater than the second number.

11. The parallel optical interface of claim 10, the first number being about 5 to 10 times greater than the second number.

12. The parallel optical interface of claim 2, further comprising substantially a polygonal block shape having a first facing surface and a second facing surface, the light pipes extending between the first facing surface and the second facing surface.

13. The parallel optical interface of claim 12, the light pipes extend substantially perpendicularly to at least one of the first or second facing surfaces.

14. The parallel optical interface of claim 2, further comprising:
a flexible shape having a first facing surface and a second facing surface;
a plurality of first end faces of the light pipes; and
a plurality of second end faces of the light pipes,
the first end faces forming a first fixed configuration on the first facing surface and the second end faces forming a second fixed configuration on the second facing surface, the light pipes extending through the flexible shape between the first and second facing surface.

15. The parallel optical interface of claim 2, the light pipes comprising at least one of optical fibers or hollow tubes.

16. The parallel optical interface of claim 1, the light sources comprising at least one of light emitting diodes, laser diodes or incandescent lights.

17. The parallel optical interface of claim 1, the first and second light sources and/or light sensors disposed on at least one of a circuit board, a back panel or an electronic unit, the electronic unit including at least one of a xerographic copier, a xerographic printer, a scanner, or a computer.

18. A parallel optical interface, comprising:
first means for light sourcing and/or light sensing;
second means for light sourcing and/or light sensing; and
optical signals separation means for coupling the first and second means.

19. A xerographic device comprising the parallel optical interface of claim 1, the xerographic device being one of a color copier, a black and white copier, or a printer.

20. A parallel optical interface, comprising:
a first plurality of light sources and/or light sensors having a first fixed physical configuration;
a second plurality of light sources and/or light sensors having a second fixed physical configuration corresponding to the first fixed physical configuration;
at least two facing surfaces coupling the first and the second plurality of light sources and/or light sensors;
a plurality of light pipes extending between two of the at least two facing surfaces, each of the light pipes coupling one of the first light sources and/or light sensors to one of the second light sources and/or light sensors; and
a first number of light pipes and a second number of the first plurality of light sources and/or light sensors, the first number being greater than the second number.
